(19) United States
(12) Patent Application Publication
(10) Pub. No.: US 2010/0161992 A1
(43) Pub. Date: Jun. 24, 2010

(54) Device and method for protecting data, computer program, computer program product

(76) Inventors: Torsten Schuetze, Moeglingen (DE); Jens Liebehenschel, Liederbach (DE)

Correspondence Address: Striker, Striker & Stenby, 103 East Neck Road, Huntington, NY, 11743, US

(21) Appl. No.: 12/641,792

(22) Filed: Dec. 18, 2009

(30) Foreign Application Priority Data
Dec. 22, 2008 (DE) 102008055076.0

(51) Int. Cl. H04L 9/32

(52) U.S. Cl. 713/176

(57) ABSTRACT

A device and method for protecting data in which preset data (m) are stored in a first memory in a control unit; the data (m) are signed with a signature (σ_i) by a subscriber (i) belonging to a group of subscribers (1 . . . n) participating in a signature procedure; the signature is generated as a function of a first key (gsk_i) associated with the subscriber (i); the signature (σ_i) is stored in a second memory in the control unit; before the use of the data (m), a second key is used to verify whether the preset signature (σ_i) was generated by one of the subscribers (i) belonging to the group of subscribers (1 . . . n); and the signature (σ_i) contains an encrypted value, which characterizes the identity of the signing subscriber (i) and is to be decrypted by means of a third key.

### CROSS-REFERENCE TO RELATED APPLICATION

The invention described and claimed hereinbelow is also described in German Patent Application DE 10 2008 055 076.0 filed on Dec. 22, 2008. This German Patent Application, whose subject matter is incorporated here by reference, provides the basis for a claim of priority of invention under 35 U.S.C. 119(a)-(d).

### BACKGROUND OF THE INVENTION

Digital signatures are used in IT systems and in embedded devices for achieving the following security objectives:

Integrity: Intentional modifications to signed data will be reliably detected, i.e. the data and the associated signature cannot be changed without this change being conspicuous in a signature verification.

Authenticity: Only a signer of the data (sender) is able to generate a correct signature, i.e. no one other than the sender himself can successfully pass himself off as the signer of the data.

Non-repudiability: The signer cannot subsequently repudiate a signature once it has been executed, i.e. each signature can be unambiguously associated with one particular signer.

Typically, so-called Public Key methods are used to achieve these security objectives. In these methods, each subscriber A of a communication system has a signature key pair composed of a private signature key and a public signature key. The key pairs for the individual subscribers are generated in a protected environment, for example a trust center. Then, the private signature key provided for a particular subscriber is sent to the corresponding subscriber. The public signature verification key is made publicly accessible to all subscribers of the communication system.

To sign a message, typically a suitable hash function is used that reduces the data to a hash value with a fixed, short length, typically of 160 Bits. This hash value is then signed with the private signature key by means of a suitable encryption method, the signature algorithm. To generate the hash value, for example a SHA1 sum is generated from the data. For example, the so-called RSA encryption is selected for the encryption. The signing procedure yields a digital signature whose length depends on the selected key length.

The recipient of the message or data uses this hash function again and, by means of an authentic copy of the public signature verification key of the sender, verifies the validity of the digital signature. To verify the signature, the RSA algorithm, for example, is likewise used as a verification algorithm. If the verification algorithm confirms the validity of the signature, this assures the integrity and authenticity as well as the non-repudiability of the signature procedure of the data since no one other than the owner of the private signature key can have generated the signature and any change to the data results in a changed signature.

In order to ensure that the public signature verification key is authentic, the public signature verification key is signed, for example, by the trust center. In addition to the private signature key, every subscriber of the communication system also receives a certificate of the trust center. This certificate is used to verify the authenticity of any public signature verification key.

Control units of the kind typically used in motor vehicles offer the possibility of importing external data into the control unit, i.e. storing it in a memory provided in the control unit. Cryptographic methods, for example, are used in order to permit only authorized persons to store data in the memory of the control unit.

If a subscriber wishes to store data in the control unit, then he first signs these data using his private signature key. Then in the control unit, a verification is performed as to whether the data have been signed by an authorized subscriber. The data are only stored in the memory of the control unit if the signature is the signature of an authorized subscriber. But this means that the public signature verification key of each authorized subscriber must be available in the control unit in order to be able to verify the signatures of all possible subscribers.

### SUMMARY OF THE INVENTION

The device according to the invention and the method according to the invention, the computer program, and the computer program product have the advantage over the prior part that preset data (m) are stored in a first memory in a control unit; the data are signed with a signature by a subscriber belonging to a group of subscribers participating in a signature procedure; the signature is generated as a function of a first key associated with the subscriber; the signature is stored in a second memory in the control unit; before the use of the data, a second key is used to verify whether the preset signature was generated by one of the subscribers belonging to the group of subscribers; and the signature contains an encrypted value, which characterizes the identity of the signing subscriber and is to be decrypted by means of a third key.

It is thus possible to verify the authenticity of a signature of any subscriber by means of exactly one public signature verification key while simultaneously achieving the security objectives of integrity, authenticity, and non-repudiability. To that end, data to be stored in the control unit are signed with a signature. The signature is generated by means of a group signature procedure in which each subscriber belonging to a group of subscribers participating in the group signature procedure has exactly one secret private key for generating the signature. For this purpose, each subscriber participating in the group signature procedure receives, for example, a private, secret key and, in an encrypted form that cannot be read by the subscriber himself, information about himself as the source of the signature. The information that cannot be read by the subscriber himself is encrypted by means of a secret key of a group manager. Only in the event of disputes, the group manager uses this information to reveal the identity of the subscriber. The signature is generated based on the private, secret key, on the encrypted source information, and on the data themselves. As a result, on the one hand, the signature is thus unambiguously associated with one subscriber, who is participating in the signature procedure, as the source. On the other hand, the signature is also unambiguously associated with the signed data.

By means of the above-mentioned group signature procedure, all of the signatures that have been generated by any subscriber belonging to the group of subscribers participating in the group signature procedure can then be verified by means of the same public signature verification key. Consequently, only one public signature verification key is required. This is true even if new subscribers are added to the group after the public signature verification key has been generated. In the control unit, the public signature verification key is stored in a read-only memory, for example during manufacture of the control unit. Then, by means of the public signature verification key, a verification is run as to whether the signature with which the data to be stored were signed has actually come from a subscriber belonging to the group of subscribers participating in the group signature procedure. If this is the case, then the occurrence of a manipulation by an unauthorized third party can be ruled out with a high degree of probability.

It is particularly advantageous if the verification is carried out in a computing device in the control unit itself. This enables a maximum protection of data after an intervention from outside the control unit, without requiring external verification devices.

It is particularly advantageous if a program, which runs on the computing device in the control unit itself in order to carry out the verification, is stored in a third memory, which is protected from manipulation, in the control unit. As a result, the verification of the data can be carried out in the control unit with a program that is protected from manipulation for example by means of the structure type and the selected memory. This increases the protection against manipulation of the data in the first memory and of the signature in the second memory. The structure is selected, for example, so that an attempt to alter the data in the third memory inevitably leads to the destruction of the third memory.

It is particularly advantageous if the verification is carried out in a computing device outside of the control unit itself. This permits the data and the signature to be verified outside of the control unit, even in a repair shop. It is thus possible, for example, to prove that a manipulation has already occurred.

It is particularly advantageous if the data in the control unit are only used when the verification of the preset signature shows that the data were generated by one of the subscribers belonging to the group of subscribers. As a result, the only data accepted are those that have been generated by authorized subscribers of a previously established group.

It is particularly advantageous if the signature is determined on the basis of the data and the first key while the first key is determined on the basis of a preset number of subscribers and a preset key length. Because of this, proven and efficient algorithms are used, which ensure a reliable protection of the data and a rapid calculation that is optimized in terms of calculation time.

It is particularly advantageous if each subscriber belonging to a group of subscribers is associated with exactly one first key. This ensures that it is possible to unambiguously determine which of the subscribers has generated a signature. Since the data in the control unit are only accepted if the signature in the memory of the control unit matches the data, it is thus possible in the event of damage, to unambiguously determine the subscriber that signed the data contained in the control unit by reading out the signature from the control unit.

It is particularly advantageous if the verification of whether the signature was generated by one of the subscribers belonging to the group of subscribers is carried out on the basis of a preset second key. The use of the second key prevents the personal information about the subscriber that generated the signature from being decrypted. This information cannot be decrypted using the second key.

It is particularly advantageous if the second key is only used to verify whether the signature was generated by one of the subscribers belonging to the group of subscribers. This reliably verifies whether an authorized subscriber has signed the data in the control unit. The information about the subscriber that signed the data remains secret. Thus the checking and verification of signatures of all subscribers participating in the signature procedure advantageously require only one public group certificate or one public group key and one trust center certificate. This saves computing resources and reduces costs by comparison with a method in which for M subscribers with M signatures, it is also necessary to verify M certificates or public keys and store them as needed.

It is particularly advantageous if the decryption of the encrypted information contained in the signature takes place by means of a preset third key on the basis of the data and the signature. It is thus possible to reliably determine the identity of the subscriber that signed the data. This is important in the event of damage, for example, in order to permit unambiguous identification of the responsible party.

It is particularly advantageous if the value, which is contained in the signature and characterizes the identity of the subscriber, is either a piece of information about the first key, the first key itself, or the subscriber himself. The method is thus adapted to the requirements of the user in various and flexible ways.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 schematically depicts the structure of a signature key generation device,

FIG. 2 schematically depicts the structure of a signature generation device,

FIG. 3 schematically depicts the structure of a signature verification device,

FIG. 4 schematically depicts the structure of a device for revealing identity,

FIG. 5 shows a first flowchart,

FIG. 6 shows a second flowchart,

FIG. 7 shows a third flowchart.

### DESCRIPTION OF THE PREFERRED EMBODIMENTS

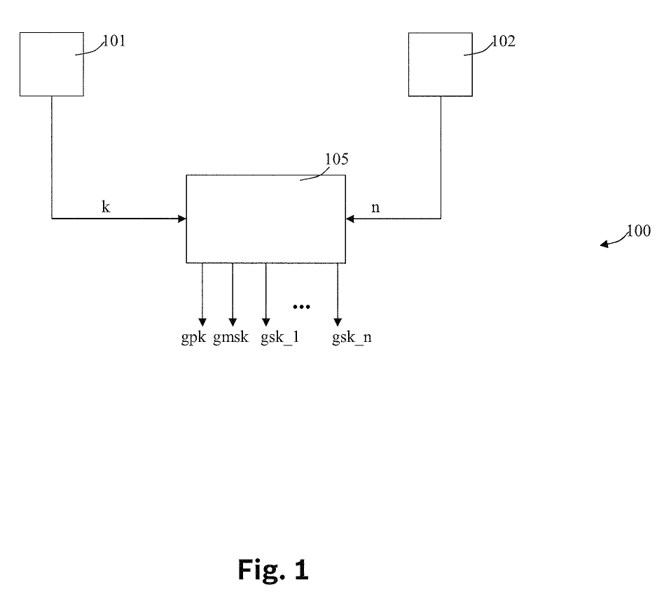

A signature key generation device, for example a workstation, shown in FIG. 1 and is labeled with the reference numeral 100. The signature key generation device is part of a secure environment, for example of a trust center.

The signature key generation device 100 includes a first presetting device 101, which presets a key length k. The signature key generation device 100 also includes a second presetting device 102 that presets a number n of subscribers in a group signature scheme.

A third presetting device 105, which is also provided in the signature key generation device, uses a so-called Group Key Generation Algorithm to generate the following values, on the basis of the key length k and the number n of subscribers in the group signature scheme:
a single public group key gpk,
a single secret group manager key gmsk,
n secret group signature keys gsk_i=gsk_1 . . . gsk_n.

For example, the algorithms described by Ateniese et al, Bellare et al, or Boneh et al are used as the Group Key Generation Algorithm.
Giuseppe Ateniese, Jan Camenisch, Marc Joye, and Gene Tsudik. A Practical and Provably Secure Coalition-Resistant Group Signature Scheme. In volume 2656 of Lecture Notes in Computer Science, pages 614-629. Springer, 2003.
Mihir Bellare, Daniele Micciancio, and Bogdan Warinschi. Foundations of Group Signatures: Formal Definitions, Simplified Requirements, and a Construction Based on General Assumptions. In Eli Biham, editor, Proceedings of Eurocrypt '03,
Dan Boneh, Xavier Boyen, and Hovav Shacham. Short Group Signatures. In Matthew K. Franklin, editor, Advances in Cryptology—CRYPTO 2004, number 3152 in Lecture Notes in Computer Science, pages 41-55. Springer-Verlag, 2004.

The secret group signature keys gsk_i are distributed, for example, in the form of chip cards to the n subscribers participating in the group signature procedure. The chip cards are produced, for example, by means of a chip card writer that is connected to the workstation.

The trust center signs the public group key gpk in a known way with the signature of the trust center. The group certificate thus generated is published in a known way, for example on an Internet server of the trust center.

The secret group manager key gmsk is also stored, for example, on a chip card and remains in possession of the group manager. The group manager keeps the group manager key secret.

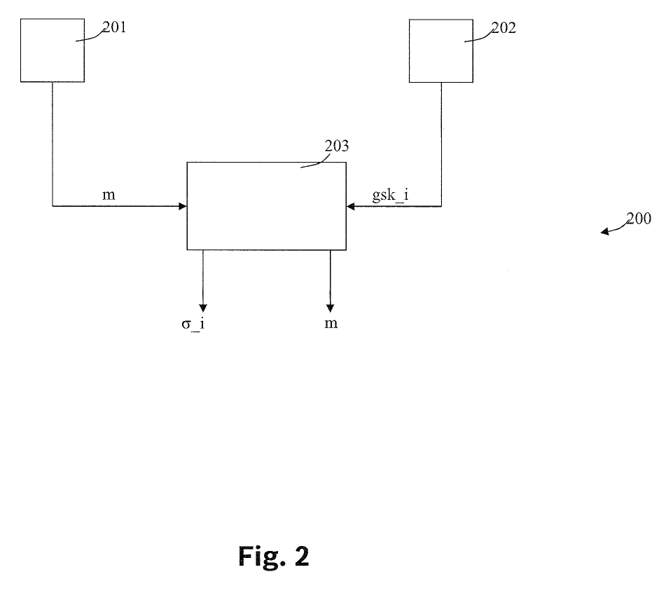

A signature generation device is shown in FIG. 2 and is labeled with the reference numeral 200. The signature generation device includes a fourth presetting device 201 that presets the data m. The data m are useful data selected, for example, from an arbitrary member (i) of the group, for example in the form of a program that is provided to run in a control unit. For example, the fourth presetting device 201 is a first memory of a mobile computer in which the data m are stored. The signature generation device 200 also includes a fifth presetting device 202 that presets the secret group signature keys of the member i gsk_i. For example, the fifth presetting device 202 is the chip card of the subscriber i, which is connected to the mobile computer via a chip card reader.

The signature generation device 200 also includes a first calculating device 203, which receives the data m and the secret group signature key gsk_i of the subscriber i. The first calculating device 203 signs the data m and supplies the signature σ_i. A Group Signature Generation Algorithm is used for this, which is suitable for use with the Group Key Generation Algorithm used. This algorithm is described, for example, in Ateniese et al, Bellare et al, or Boneh et al.

The signature σ_i includes the information about the subscriber i in an encrypted form. One property of the group signature algorithm is that aside from the group manager, no subscriber i is in a position to deduce the identity of the signer, i.e. of the subscriber, from the signature σ_i. Only the group manager can, for example in the event of a dispute, reveal the identity of the signer, i.e. of the subscriber i, with absolute certainty using a suitable opening procedure.

The signature σ_i and the data m are output by the first calculating device 203, as shown in FIG. 2. For example, the data m, together with the signature σ_i, are output by the mobile computer via a serial data line to the control unit, for example in a motor vehicle.

The control unit is embodied so that both the data m and the signature σ_i are stored, for example, in a second memory in the control unit.

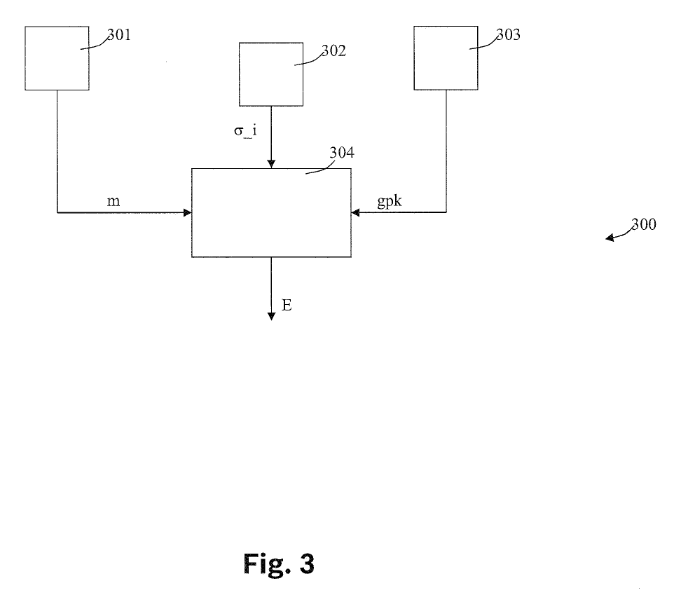

A signature verification device is shown in FIG. 3 and is labeled with the reference numeral 300. The signature verification device 300 includes a sixth presetting device 301 that presets the data m. For example, the sixth presetting device 301 is the memory in the control unit. The signature verification device 300 also includes a seventh presetting device 302, which presets the signature σ_i. For example, the seventh presetting device 302 is the memory in the control unit.

The signature verification device 300 also includes an eighth presetting device 303 that presets the public group key gpk. For example, the eighth presetting device 303 is the Internet server of the trust center that transmits the group certificate containing the public group key gpk.

The data m, the signature σ_i, and the public group key gpk are transmitted to a second calculating device 304, as shown in FIG. 3. For example, the second calculating device 304 is the mobile computer. For example, the memory in the control unit is connected to the mobile computer via a serial data line in order to transmit the data m and the signature σ_i. The Internet server is connected to the mobile computer via a computer network.

A verification procedure is stored in the second calculating device 304. This verification procedure is selected to be suitable for use with the Group Key Generation Algorithm. For example, the verification procedure uses a known method to first verify whether the group certificate has actually come from the trust center. Typically, this is accomplished using a trust center certificate that is issued by the trust center and is permanently stored in the signature verification device 300.

Then the verification procedure uses the public group key gpk and the data m to verify whether the signature σ_i has actually been supplied by a subscriber i of the group. At the same time, a verification is run as to whether the data m were actually signed with the signature σ_i. The algorithm on which the verification procedure is based is likewise described, for example, in Ateniese et al, Bellare et al, or Boneh et al.

The second calculating device 304, for example a computer, outputs the result E of the verification. For example, the data m are in the form of a program (software version) that is to be run on the control unit. For example, the result “software version uncorrupted” is displayed on a screen of the mobile computer when the verification determines that the signature σ_i was generated by a subscriber i of the group. Otherwise, the result “software version corrupted” is displayed. Due to the property of the group signature procedure, the result “software version uncorrupted” means that the source of the data m that are stored in the control unit can be absolutely attributed to the group. Likewise due to the property of the group signature procedure, the identity of the subscriber i cannot be determined by means of the public group key. These personal data of the subscriber i are thus protected from being accessed by subscribers other than the group manager.

Consequently, the testing and verification of signatures σ_i of all subscribers i participating in the signature procedure require only one group certificate or one public group key and one trust center certificate in the calculating device 304. This saves computing resources and reduces costs by comparison with a method in which for M subscribers with M signatures, it is also necessary to verify M certificates or public keys and store them as needed.

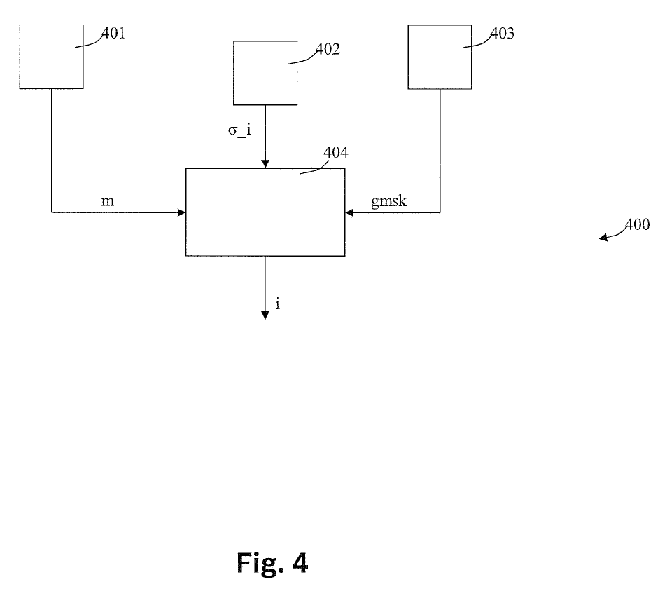

A device for revealing identity is shown in FIG. 4 and is labeled with the reference numeral 400. The device for revealing identity 400 includes a ninth presetting device 401, which presets the data m. For example, the ninth presetting device 401 is the memory in the control unit. The device for revealing identity 400 also includes a tenth presetting device 402, which presets the signature σ_i. For example, the tenth presetting device 302 is the memory in the control unit.

The device for revealing identity 400 also includes an eleventh presetting device 403, which presets the secret group manager key gmsk. For example, the eleventh presetting device 403 is a chip card reader that reads the chip card of the group manager.

The data m, the signature σ_i, and the secret group manager key gmsk are transmitted to a third calculating device 404 as shown in FIG. 4. For example, the third calculating device 404 is the mobile computer. For example, the memory in the control unit is connected to the mobile computer via a serial data line for the transmission of the data m and the signature σ_i. For example, the chip card reader is likewise connected to the mobile computer.

An opening procedure is stored in the third calculating device 404. This opening procedure is selected to be suitable for use with the Group Key Generation Algorithm so that it is suitable for decrypting the information about the subscriber i. The algorithm on which the opening procedure is based is likewise described, for example, in Ateniese et al, Bellare et al, or Boneh et al.

The third calculating device 404 opens the signature σ_i and outputs the identity of the subscriber i. For example, the identity of the subscriber i is displayed on a screen of the mobile computer.

This provides definitive proof of the source of the data m that are stored in the control unit. At the same time, a subscriber other than the group manager is prevented from being able to read this information.

The device according to the invention and the method according to the invention, however, are not limited to the group signature algorithms described in Ateniese et al, Bellare et al, or Boneh et al.

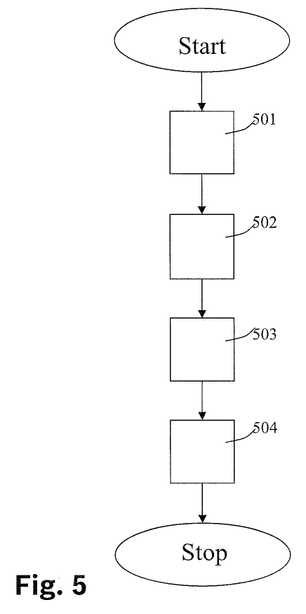

The method for generating the signature σᵢ is shown in FIG. 5 and will be described in detail below.

The method is started when a user of the control unit wishes to sign data m for use in the control unit. To do so, the method is presented in a computer program that is run on a workstation such as a PC.

After the method is started, a step 501 is carried out.

In step 501, the data m are preset. Then the method continues in a step 502.

In step 502, the second key gsk_i, i.e. the private signature key, is preset. Then the method continues in a step 503.

In step 503, the signature σ_i is determined in accordance with the known group signature method. Then the method continues in a step 504.

In step 504, the signature σ_i and the data m are output. For example, the data m are stored in the first memory of the control unit and the signature σ_i is stored in the second memory.

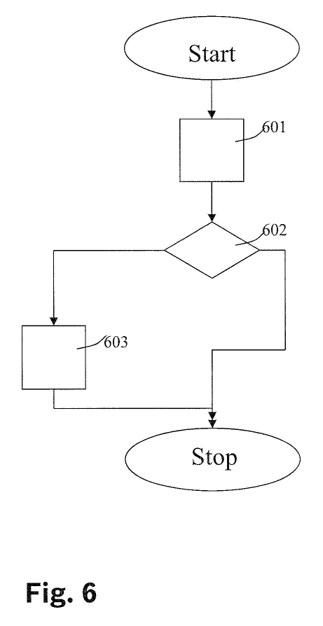

FIG. 6 shows a flowchart that is implemented, for example, in the form of a computer program and is stored in a third memory in the control unit. The third memory is structurally protected from manipulation and cannot be filled with new memory content without destroying it.

If a user of the control unit wishes to store new data m in the first memory in the control unit, the method described in the flowchart in FIG. 6 is started.

After the start, a step 601 is carried out.

In step 601, the data m and the first signature σ_i are preset. Then the method continues in step 602.

In step 602, depending on the second key gpk and the data m, the group signature algorithm is used to verify whether the signature determined from the second key gpk and the data m corresponds to the preset signature σ_i. If the signature verification, which is carried out with the second key gpk and the data m, determines that the signature σ_i is valid, then the method continues in a step 603. Otherwise, the method is terminated.

In step 603, the data m are stored in the first memory and the preset signature σ_i is stored in the second memory and the method is terminated.

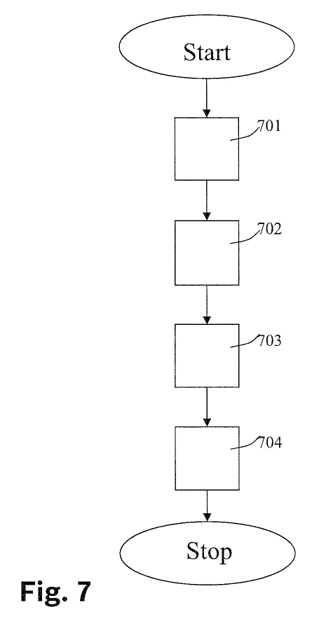

To determine the source of the data m stored in the first memory in the control unit, the method represented in the flowchart from FIG. 7 is started. After the start, a step 701 is carried out.

In step 701, the data m are read from the first memory and the signature σ_i is read from the second memory. Then a step 702 is carried out.

In step 702, the third key gmsk is preset. The presetting of the third key gmsk is carried out, for example, by means of a removable memory, for example a chip card. Then a step 703 is carried out.

In step 703, the identity of the source, i.e. a value that characterizes the identity of the source of the first signature σ_i, is determined. The algorithm known from the group signature method is used for this. Then the method continues in a step 704.

In step 704, the identity of the source of the data m, i.e. the subscriber i that generated the signature σ_i, is output. Then the method is terminated.

The methods depicted in the flowcharts of FIGS. 5, 6, and 7 are preferably implemented in the form of a computer program and are stored, for example, on a computer program product such as a data storage medium.

It will be understood that each of the elements described above, or two or more together, may also find a useful application in other types of methods and constructions differing from the types described above.

While the invention has been illustrated and described as embodied in a device and method for protecting data, computer program, computer program product, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for protecting data, comprising the steps of storing preset data (m) in a first memory in a control unit; signing the data (m) with a signature (σ_i) by a subscriber (i) belonging to a group of subscribers (1 . . . n) participating in a signature procedure; generating the signature as a function of a first key (gsk_i) associated with the subscriber (i); storing the signature (σ_i) in a second memory in the control unit; before the use of the data (m); using a second key to verify whether the preset signature (σ_i) was generated by one of the subscribers (i) belonging to the group of subscribers (1 . . . n); and providing in the signature (σ_i) an encrypted value, which characterizes the identity of the signing subscriber (i) and is to be decrypted by means of a third key.

2. The method as recited in claim 1, further comprising carrying the verification out in a computing device in the control unit itself.

3. The method as recited in claim 2, further comprising storing a program, which runs on the computing device in the control unit itself in order to carry out the verification, in a third memory in the control unit that is protected from manipulation.

4. The method as recited in claim 1, further comprising carrying out the verification in a computing device outside of the control unit itself.

5. The method as recited in claim 2, further comprising only using the data (m) in the control unit if the verification of the preset signature (σ_i) shows that the data (m) were generated by one of the subscribers (i) belonging to the group of subscribers (1 . . . n).

6. The method as recited in claim 1, further comprising determining the signature (σ_i) on the basis of the data (m) and the first key (gsk_i) while the first key (gsk_i) on the basis of a preset number (n) of subscribers and a preset key length (k).

7. The method as recited in claim 6, further comprising associating each subscriber (i) belonging to a group of subscribers (1 . . . n) with exactly one first key (gsk_i).

8. The method as recited in claim 1, further comprising carrying out the verification of whether the signature (σ_i) was generated by one of the subscribers (i) belonging to the group of subscribers (1 . . . n) on the basis of a preset second key (gpk).

9. The method as recited in claim 8, further comprising only using the second key (gpk) to verify whether the signature (σ_i) was generated by one of the subscribers (i) belonging to the group of subscribers (1 . . . n).

10. The method as recited in claim 9, further comprising providing the decryption of the encrypted information contained in the signature (σ_i) by means of a preset third key (gmsk) on the basis of the data (m) and the signature (σ_i).

11. The method as recited in claim 6, further comprising providing in the value, which is contained in the signature (σ_i) and characterizes the identity of the subscriber (i), a piece of information about the first key (gsk_i), the first key (gsk_i) itself, or the subscriber (i) himself.

12. A device for protecting data, comprising a first memory in a control unit, in which present data (m) are stored; a first calculating device determines a signature (σ_i) for signing of the data (m) by a subscriber (i) belonging to a group of subscribers (1 . . . n) participating in a signature procedure; a first key (gsk_i) associated with the subscriber (i), on the basis of which the signature is generated;
a second memory in the control unit in which the first calculating devices stores the signature (σ_i), wherein the signature (σ_i) contains an encrypted value characterizing an identity of the signing subscriber; and a third key in which the signature (σ_i) containing an encrypted value which characterizes an identify of the signing subscriber is decrypted.

13. A device for protecting data, comprising a first memory in a control unit, in which preset data (m) are stored; a second memory in which a preset signature (σ_i) is stored; a second calculating device which, before a use of the data, uses a second key to verify whether the preset signature (σ_i) was generated by a subscriber (i) belonging to a group of subscribers (1 . . . n) and the signature (σ_i) contains an encrypted value; and a third key in which the signature (σ_i) containing an encrypted valued which characterizes an identity of the signing subscriber is decrypted.

14. A device for protecting data, comprising a first memory in a control unit, in which preset data (m) are stored; a second memory in which a preset signature (σ_i) containing an encrypted value which characterizes the identity of the signing subscriber (i); a third key decrypting the preset signature containing the encrypted value which characterizes the identity of the signing subscriber, and a third calculating device using the third key to determine the identify of a signing subscriber.

15. A computer program that executes the steps of a method as recited in claim 1 when it is run on a computing device.

16. A computer program product having programming code, which is stored on a machine-readable medium, for carrying out the method recited in claim 1, when the program is run on a computer or control unit.
